(19) United States
(12) Patent Application Publication
(10) Pub. No.: US 2007/0160961 A1
(43) Pub. Date: Jul. 12, 2007

(54) TRANSPORTATION SIMULATOR

(76) Inventor: Cyrus Lum, Austin, TX (US)

Correspondence Address: DUBOIS, BRYANT, CAMPBELL & SCHWARTZ, LLP, 700 LAVACA STREET, SUITE 1300, AUSTIN, TX, 78701, US

(21) Appl. No.: 11/622,292

(22) Filed: Jan. 11, 2007

Related U.S. Application Data
(60) Provisional application No. 60/758,081, filed on Jan. 11, 2006.

(51) Int. Cl. A63F 13/00; G09B 9/02

(52) U.S. Cl. 434/29; 463/1

(57) ABSTRACT

A simulator of various forms of mass transportation wherein one or more users interact with the vehicles as free-roaming, first-person avatars. This simulation will also allow a user and or multiple users to simulate various job duties associated with mass transportation. This simulation will broadcast jobs or tasks that one or many users may bid on in exchange for credits and increases in data representing skill and experience upon real-time performance evaluation and task completion. The users receive a rating which can change the user's experience within the simulation. The simulator allows the user to design the track or roadways upon which the vehicles operate. The simulator also allows the user to design the vehicle used by the user. The simulator may be used by a single user on a single machine or by multiple users in remote locations.

### PRIORITY CLAIM

The application claims the benefit of priority under 35 U.S.C. §119(e) from U.S. Provisional Application No. 60/758081, entitled, “Train Artisan's TA Railway,” filed on Jan. 11, 2006, which disclosure is fully incorporated herein by reference.

### BACKGROUND OF THE INVENTION

There are a wide variety of transportation simulators commercially available today. However, most simulators use a single avatar to represent the user of the simulator and that avatar is relegated to a single location within the vehicle. For example, in a flight simulator the avatar can represent either a pilot or a co-pilot; in a train simulator, the avatar can represent an engineer; and in a fire truck, the avatar can represent a fireman. In some cases, the avatar is only the drivable vehicle itself. This limits the ability of the user to learn firsthand information about the vehicle by, for example, climbing onto the wing of an airplane or the roof of a train.

Because simulators of public and or private mass transit and freight transportation known in the art today do not allow the avatar to move freely inside and outside the vehicle, it is only possible for these simulators to simulate the actual driving or operation of the vehicle. However, it is often important for operator to gain skills associated with operating a vehicle but which are performed in positions other than the driver's or operator's seat. By allowing the user's avatar to move out of the driver's or operator's seat, it is possible to simulate many other job duties. A user's duties are no longer limited to just driving a vehicle. A user can also perform job duties such as: serving as a stewardess on a plane, serving as the flight engineer, being a conductor or a brakeman on a train, or even serving as the switchman stationed at the tower or a ticket agent at the station. The number of jobs that users can simulate and the ability for a user to cross-train in different jobs, is unlimited. There is a need, therefore, for an improved simulator which allows the user's avatar to move in and around the vehicle.

Currently, simulators do not allow multiple users to operate or move around in the same vehicle or even see each other. As a result, in the case of mass transit or multiple vehicles, each user's avatar is not able to “see” another user's avatar. As a result, it is not possible for one user to provide feedback to another user through the experience of that user's avatar. This type of information could be used for, among other things, evaluating job performance. There is a need therefore for an invention that allows multiple users to see each other, communicate with each other, and operate the same equipment together.

Another drawback to simulators currently known in the art is the inability to distribute tasks using a bid system. For example, it would be useful for a simulator to provide user's of the simulator to bid on tasks which are distributed by the simulator. The successful bidder could be given specific information about the task and could be evaluated during the performance of the task. The user could also receive adjustments to his skills, experience credits, and currency credits. There is a need therefore for a simulator that allows tasks to be distributed through a bid system and for players to be subsequently evaluated based on their performance of the task.

Another drawback to simulators known in the art is that they limit the number of simultaneous users, typically from 2 to 8, and the number of unique vehicles available in the simulation. There is a need, therefore, for a simulator in which the vehicles can be constructed from a common parts library which allows a greater number of unique vehicles under performance limitations.

With simulators currently known in the art, it is not possible to effectively develop and test conceptual vehicles or vehicle parts by multiple parties. This is particularly useful in public transportation where it is necessary to produce equipment that is accessible by, and functional for, a wide variety of people. There is a need, therefore, for a simulator whereby a user or multiple users can collaboratively test ideas, theories, or case studies in a safe and relatively cost free, virtual environment.

### BRIEF SUMMARY OF THE INVENTION

In accordance with at least one preferred embodiment, the present invention provides a simulator of various forms of mass transportation wherein one or more users interact with the vehicles as free-roaming, first-person avatars. The user interacts with the avatars through an interface which has multiple, resizable windows through which the user can view any area of interest in the simulator. Multiple avatars may be controlled by either a single user or multiple users and each avatar can see the actions of the other avatars in real time.

In various embodiments, the simulator of the present invention allows users to interactively design the avatars used by the user, the vehicles used by the avatars, the environment in which the vehicles and avatars exist, and the track or roadway upon which the vehicles travel.

In some embodiments, a user or multiple users perform various job duties associated with mass transportation. The users receive a rating which can change the user's experience within the simulation. The simulator may be used by a single user on a single machine or by multiple users in remote locations accessing the simulator through a network.

### BRIEF DESCRIPTION OF THE DRAWINGS

In the following detailed description of embodiments of the invention, reference is made to the accompanying drawings, which form a part hereof, and in which is shown by way of illustration specific exemplary embodiments in which the invention may be practiced, and in which like numbers represent the same or similar elements and one or a plurality of such elements, as follows:

FIG. 1 is a depiction of a screen shot showing free-roaming avatars near a train;

FIG. 2 is a depiction of a screen shot showing multiple views in a single window;

FIG. 3 is a depiction of a screen shot showing multiple avatars in a single car;

FIG. 4 is depiction of a screen shot showing the vehicle editor tool; and

FIG. 5 is a depiction of a screen shot showing the track editor tool.

### DETAILED DESCRIPTION

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct electrical or communicative connection. Thus, if a first component couples to a second component, that connection may be through a direct connection, or through an indirect connection via other devices and connections. Also, the term “avatar” means any graphical or electronic image or data used to represent a user of a simulator. The term “mass transportation” means any form of transporting a plurality of people or goods, including public and or private mass transit and freight transportation. The term “vehicle” means a device or apparatus used to transport people or goods. The term “simulator” means any device wherein real events are simulated in a virtual environment. It is further noted that all functions described herein may be performed in either hardware or software, or a combination thereof, unless indicated otherwise.

In various embodiments of the invention, one or more users interact with different forms of mass transportation as free-roaming, first-person avatars in a simulator. In one embodiment of the invention, the user may be assigned a job associated with mass transportation. In still other embodiments, the user may be rated on the performance of that job and that rating may change the user's experience in the simulator. The graphics in the simulator are preferably rendered in 3-dimensional mode which better simulates the manner in which vehicles operate.

In one embodiment of the present invention, users interact with the simulator through a special interface. This interface uses commonly available software in combination with a computer keyboard, and computer mouse to simulate human factors and ergonomics, thereby allowing the user to have a free-roaming, first person viewpoint. With this interface, the user will be able to move freely in all directions. The user will also be able to use a point, click and drag interface to operate, manipulate, and exist with public and private transportation vehicles and to interact with other users inside the simulator. The simulator may include multiple resizable windows which may be moved by the user and through which the user can view any area of interest in the simulator. For example, a user simulating a train engineer may elect to “look” to the back of the train by pointing view window rearward. The view windows may be locked in fixed positions, such as 90-degree angles from the primary view to provide a peripheral vision effect. In addition, there may be a plurality of view windows to create a more immersive simulation experience.

Since the simulator of the present invention simulates the ergonomics of working with and operating public and private transportation vehicles, it is necessary to have a system for constructing, displaying, storing and transmitting these vehicles within the simulator. In one or more embodiments, the simulator may contain a system for compressing a large number and variety of vehicles with the use a common parts library which the user may use for the construction of vehicles. This allows for the inclusion of a large number and variety of vehicles into the simulator. Vehicles can be constructed from common parts library (e.g. wheels, car bodies, propellers, and the like) in the software program loaded into the software program and the parts may be assembled from the parts library to create a vehicle. Vehicles are preferably constructed to scale. Each piece in the library contains its own levels of detail, textures, animation, and materials, along with other data necessary for the simulator. This allows, among other things, for the data files storing vehicle information to be substantially smaller than those that would be required for storing entire vehicles. The library may also include a method for modifying or changing parts.

Some embodiments of the invention also include a method for modifying or changing parts. Data in the simulator may be stored in a compressed form whereby parts are generated from a small set of attributes. Instead of storing all of the data for the geometry, textures, materials and texturing data, such as UV coordinates, parts are generated by the software “on the fly” based on a set of attributes designated by the user. This system allows data files to be compressed to a size where they are capable of being transmitted at a sufficiently low bit rate to enable a massively multiplayer simulation experience.

It may also be desirable to reduce the size of files used for textures by blending textures from smaller files to create new and unique textures for vehicles and parts in the simulator. It also may be desirable to encrypt certain design attributes in the simulator, such as the geometry, texture, and material data, to protect proprietary designs and the user's rights inherent therein. This can be particularly useful when the simulator is accessible online.

In one embodiment of the invention, users can interactively design, manipulate and construct a virtual environment for these vehicles to traverse. This invention includes systems and interactive tools to allow a user to create, manipulate, store and transmit data terrain, roads or whatever is necessary to allow the vehicles to travel in the simulation. This can be very useful if the user is interested in testing hypothetical vehicle designs or users' experience in a dangerous situation. The editor tools are integrated into the simulator so, even in those cases where users are connected remotely, the users may collaborate to design vehicles used in the simulator.

One application of this invention is to test public and private transportation. Therefore, the simulation must support the interaction of many people with the vehicles. Although not required, multiple users may access the same simulator through a network, such as a local area network or the Internet. In such cases, it may be desirable to have a network or on-line server which will allow the virtual worlds to become persistent and to allow many users to simultaneously access the simulator to communicate, interact, and stay in-sync. In addition, users may elect to access the simulator through a data driven connection system such as cell phones, Sony PlayStation Portable device, personal digital assistants, or any device coupled to the Internet and the server on which the simulator resides. Because the system is data driven, any part of the simulation can be controlled either by another virtual entity or any external device such as a GPS transmitter. The system may include an interactive method for making connections.

In certain cases, one user may choose to occupy and manipulate multiple avatars. In these cases, that single user can cause an avatar to perform operations and ergonomics commonly performed by several people in a real life environment. In one embodiment, upon switching from one avatar to another, the user view switch to the point of view of the other avatar.

It may be desirable to allow various users to interact. A unique communication system in the present invention allows gestures made with the mouse to trigger animations of the avatars that will be converted to visual communication to other users in the simulation. For example, if a user moves the simulator's mouse back and forth, the avatar would wave to other avatars. Communication may be supplemented by type able text and voice.

To test the ergonomics, it may be desirable to have a system to administer test scenarios to the user or users. To add variety and create interest, the simulator may be configured to provide the user with a wide variety of experiences. For example, vehicles may be placed in extreme circumstances or in situations of extreme danger, such as stunt flying. Alternatively, the vehicles can be constructed to be anthropomorphic. The user can view the vehicles as they might have appeared in 1860's-1890's, 1890's-1930's, 1930's-1960's. The user could also use the simulator to investigate alternative events in historical settings to determine “what if” the events had been different. Adding to these scenarios, especially the historical scenarios, the invention also has a system to post process the look of the simulation to mimic the visual look of that period. In addition, the users view could be altered to reflect movie and television equipment and style from different eras in the 20^{th} century.

To add activities to the simulation, it is necessary to have a system to create tasks and objectives for the users of the simulation. These tasks may be procedurally created by the simulator or taken from a library of pre-created tasks. If procedurally created, the system will use a master scheduler system to take overall tasks for that day, month or year from a pre-created library and break it down into tasks that a single individual can perform. Once the system creates the tasks, it will broadcast these tasks to individual users based on how appropriate the task is for the user's skill ratings. The information broadcasted by the task system will contain a brief description of the task, along with the possible experience and currency credit offered for the completion of the task. A user can accept a task by placing a bid on the task through the task system interface. The simulator may accept or reject a bid based on which user bids first or on the bidding user's experience, currency, or skill ratings values. If the simulator accepts the bid, the system will send specific information, instructions, and criteria for the user to follow in order to complete the task. The task system will now engage the grading and evaluation system to record the user's performance while performing the task. Upon completion, the grading and evaluation system will forward its data to the task system which will determine if the user completed the task successfully. Successful completion will give the user the experience and currency credit associated with the task. The user's skill ratings will also be adjusted based on the grading and evaluation data. Variations of completeness or successfulness may also be rewarded through a weighted value applied to the experience and currency credit as well as the skill ratings. Skill ratings may include; coordination, mechanical aptitude, punctuality, accuracy, safety, teamwork, and seniority among others.

It may be desirable to include a mechanism for handling credits or payment generated by the system. The credits can be currency or credits capable of being applied to future activities in the simulator. The currency may be banked, spent, traded, or exchanged with other users or entities in the simulator. The system may facilitate these transactions as well as provide account information to the user.

To have an all encompassing simulation, other types of activities can be performed in the simulator. For example, the simulator may include a system for photographing and or filming/videoing activities in the simulator. The simulator may allow the user to send their recordings to others. In other embodiments, the simulator of the present invention includes virtual store interfaces that will allow real life vendors to sell product to users in the simulator. This simulator allows vendors to use any Internet backend to process and collect payment. It is possible that an exchange using currency credit could be used as well as actual money.

In other embodiments, the simulator of the present invention may control a vehicle, object or person in the virtual world. This could allow the system to demonstrate job operations to a user or to help a user to complete a task by controlling the other people, locomotives, or objects in the virtual world. The entities may be controlled procedurally through software or through a pre-made script of control. The automatic control of entities is further augmented by tools to allow a user to modify existing control or to create new automated controls.

In some cases, it may be desirable for single or multiple users to engage in pre-arranged, scripted activities. In other cases, the simulator may reproduce real world sounds, such as those of people or vehicles, to enhance the user's simulated experience.

Because the simulator allows multiple users to perform multiple jobs, it is possible to assess or evaluate a user's performance in a group environment. The system of the present invention can allow a user to be evaluated and, based on that evaluation, will adjust the user's statistics reflecting the user's success in performing the user's job functions. These statistics may impact the user's ability to perform in the simulation or the user's access to the simulator

Various embodiments of the present invention can be seen in the following examples which are not limiting but only illustrative.

### EXAMPLE 1

In one embodiment, the simulator of the present invention is delivered as software that must be installed on a computer before use. Once installed, the program executable is launched to run the simulator. The user will first be presented with an interface prompting the user to choose the users hardware configuration.

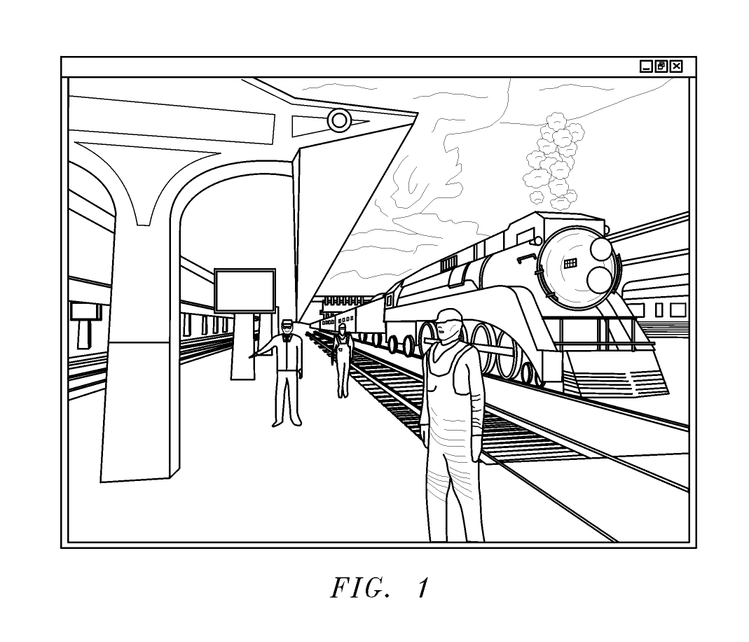

The user may then be presented with a short movie of the simulator and, thereafter, another interface where the user may choose from a number of options. These options may include, for example, choosing the control configuration for the simulation, choosing the simulation mode (such as single user, multi-user, or on-line), choosing the world scenario, or choosing user set-up. If the user chooses “user set-up,” the user is given the ability to customize the avatars. As shown in FIG. 1, the avatars interact with the train as free-roaming, first-person avatars. The “user set-up” interface allows the user to choose from among many different clothes for the user's avatar. The user may also customize the human characteristics of the avatar including the face, skin, and hair. Once this is complete, the user can choose the abilities, initial job profession, and a name for the avatar. Because the simulation supports a plurality of avatars for each user, the user may repeat the above process for any remaining avatars. In this example the user choose to set-up 3 avatars. A further option is presented to the user if multiple avatars are set-up—the ability to join the simulation as a crew or as complete individuals. Choosing a crew will assigned all avatars of the user to one specific train and will coordinate task assignments accordingly. Choosing complete individuals will relieve the simulation from this coordination and allow all avatars of the user to join separate trains or other crews. In this example, the user chose “crew.”

Once the user set-up is complete, the user selects the on-line mode from the interface. On-line mode allows the user to connect to the simulator, through the network or Internet, and join other users in a persistent simulation or scenario. Under the interface for “on-line,” the user will select which on-line scenario to join, the initial avatar the user desires to use, and where in the virtual world each of the user's avatars may enter the simulation, along with any options related to connecting to the Internet or network.

Once the user has been granted permission by the simulator, the user will join the simulation and the user's avatars will become visible to other users of that same scenario. Upon first joining the scenario, the user will be given a text message in the simulation relating the facts about the current scenario. The scenario that the user joined in this example was a historical scenario re-enacting the railroad environment of the 1930's-1960's. If the user wished, he could depress the assigned key on the keyboard to enable a black-and-white post processing filter to affect the user view. Doing this would mimic the look of the time period. To switch back to normal view, the user would simply depress the assigned key on the keyboard.

One or several task messages may appear in the user view notifying him of available tasks. Each task message will have a brief description of the task as well as the maximum experience and currency credit given to the participating avatar upon successful completion and an interface to allow the user to place a bid on the task. In this scenario, the user selects the brakeman avatar to be the starting avatar and places a bid through the interface on the task that appeared in his user view which offered 10 experience credits along with 20 currency credits. The simulation accepted the bid and now sends the user detailed information about the task while concurrently initiating the grading and evaluation system which will start recording the performance of the user's participating avatars. The task, in this example, was to travel from the crew quarters where the user first joined the simulation to the train to which the user was assigned—in this case train no. 99. The user then must align a switch for train no. 99, signal the engineer of train no. 99 to proceed so that it can move to track no. 3. At this time, the user sees a 3D representation of the inside of a crew quarters and sees sounds simulating the same real world environment. The view is a first person view and the view may include seeing other avatars of other users. Since the initial assignment for our avatar was to go to train no. 99, the user first looks at the yard map to see which track train no. 99 is on and where that is in relation to the crew quarters.

To navigate around the crew quarters, the user uses the computer mouse and keyboard. Using the mouse, the user can look around, click on objects in the view to manipulate, zoom in the view to see objects closer, gesture communications to other avatars, or move picture-in-picture windows if they are activated. Using the assigned keys on the keyboard, the user moves forward, left, back, and right in reference to the current direction of view of the user. From the yard map, the user sees that train no. 99 is on track 4. By using the mouse and keyboard, the user navigates to the door of the crew quarters, uses the assigned mouse button to click and select the door knob and drags the mouse to open the door. The user walks out of the crew quarters to the switch and signals the engineer of the locomotive to proceed.

Once the brakeman avatar has reached the switch, the user uses the assigned mouse button to click and select the switch handle, then drags the mouse to align the switch for track no. 3. The user then clicks and holds the assigned mouse button while dragging the mouse in a circular pattern. This triggers a “proceed forward” hand and arm animation on the brakeman avatar that the engineer sees. These actions are concurrently evaluated by the grading and evaluation system. Since the user followed the procedure and performed the correct actions, this will be reflected in a higher evaluation score. If the user did not follow the proper procedure, then the grading and evaluation system will record a lower score and may send a message to the user's view indicating the mistake.

In, our example, the user's second avatar is the engineer of train no. 99. The user depresses the assigned key on the keyboard to switch to the engineer avatar which also switches the user view and user location to the engineer's view point. In the engineer's point of view, the user sees a task message to move the locomotive to another track. In this example, the user places a bid which gets accepted. The simulation then sends detailed instructions to move the train over a switch to track no. 3 and engages the grading and evaluation system for the engineer. Being given the proceed signal from the brakeman avatar, the user, as the engineer, uses the assigned mouse button to click and select the whistle chord, then drags the mouse down to blow the whistle to call the fireman into the locomotive cab. This action also alerts others that the train is moving. In this example, the fireman is controlled by another user. Hearing the whistle blow, the fireman avatar runs to the locomotive cab, climbs the ladder and enters.

Once the fireman is in the cab, the user, as the engineer, clicks the assigned mouse button to select the brakes and drags the mouse to release them. The user clicks the assigned mouse button over the reverse and drags the mouse to put it into forward and finally clicks the assigned mouse button over the throttle and drags the mouse slightly to make the locomotive move forward slowly.

The locomotive moves until it passes the switch and the brakeman avatar. To clear the switch, the whole train needs to pass the brakeman and the switch. The user, as the engineer, clicks the assigned mouse button to select the side window then drags the mouse to open it. The user, as the engineer, then moves forward out the window to achieve a “head-out” view to see farther down the train. Having the head-out view might make it hard for the engineer to still see and control the throttle. To handle this, the user can enable the picture-in-picture windows by depressing the assigned key on the keyboard. This will activate a small window over the user view that can be selected with the assigned mouse button and dragged by the mouse to any location on the screen. With the mouse pointer over the picture-in-picture window, the user can rotate the view to look at the throttle.

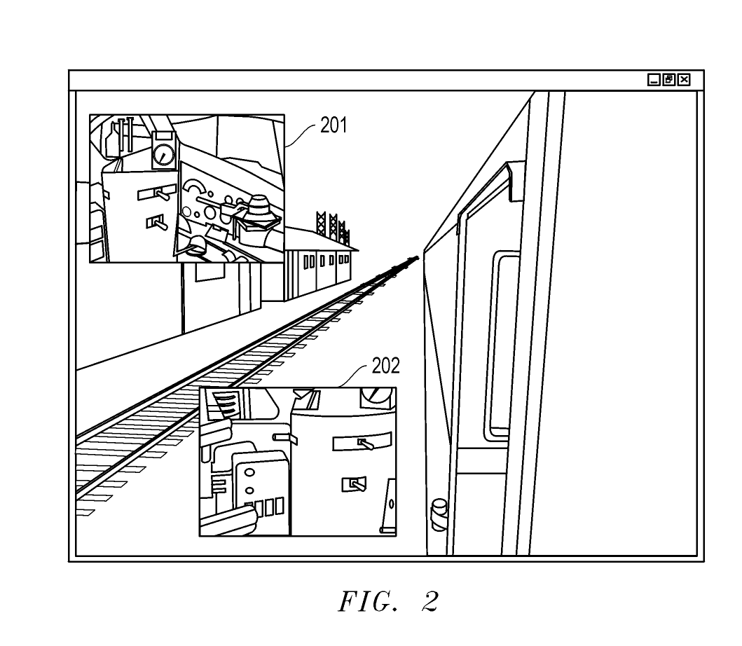

As shown in FIG. 2, the user drags the picture-in-picture window 201 up to the left side of the user view. Now, if the user has his head outside the window, he can still see the throttle control. By moving the mouse pointer over the throttle control in this smaller window, the user can click on it with the assigned mouse button and drag the throttle to speed-up or slow down the locomotive. Depressing the assigned key on the keyboard activates a second picture-in-picture window 202. Depressing another assigned key on the keyboard allows the user to resize either picture-in-picture window 201 or 202. Depressing another assigned key on the keyboard locks the two picture-in-picture windows 201 and 202 to 60 or 90 degrees from the center of the user view. Combining this feature with three computer monitors provides a substantially more immersive user experience.

If the head-out view is not enough for the engineer to tell if the complete train has cleared the switch, then the user may switch back to the brakeman by depressing the assigned key on the keyboard. The user's view now switches to the brakeman's point of view and the user can watch the train until it clears the switch. Once clear, the user clicks the right mouse button and drags the mouse left and right along the bottom of the screen to gesture a “stop” motion. Finally, the user switches back to the engineer's point of view with the assigned key on the keyboard, clicks the assigned mouse button to select the throttle, and drags it back to stop the locomotive. The evaluation and grading system recorded the performance of all participating avatars and this will be reflected in each avatar's skill rating. This data will also be used to determine the level of successful completion of the tasks and may be used to weight the ratings and credits at a later time. The currency received from the completed task is automatically added to each avatar's account. The user can access this through the interface of each avatar's point of view.

The user's third avatar in this example was the conductor who was in the last passenger car of train no. 99. The user switches to the conductor's point of view by depressing the assigned key on the keyboard and uses the mouse and keyboard to walk through the passenger cars, taking tickets from passengers who may be other user avatars in the simulation. In our case, the passenger must pay currency credit to the conductor. To do this, the user accesses the currency interface of the passenger avatar and selects the pay option, the amount to pay, and selects the complete transaction option. This currency credit is now subtracted from the passenger's account and added to the conductor avatar's account.

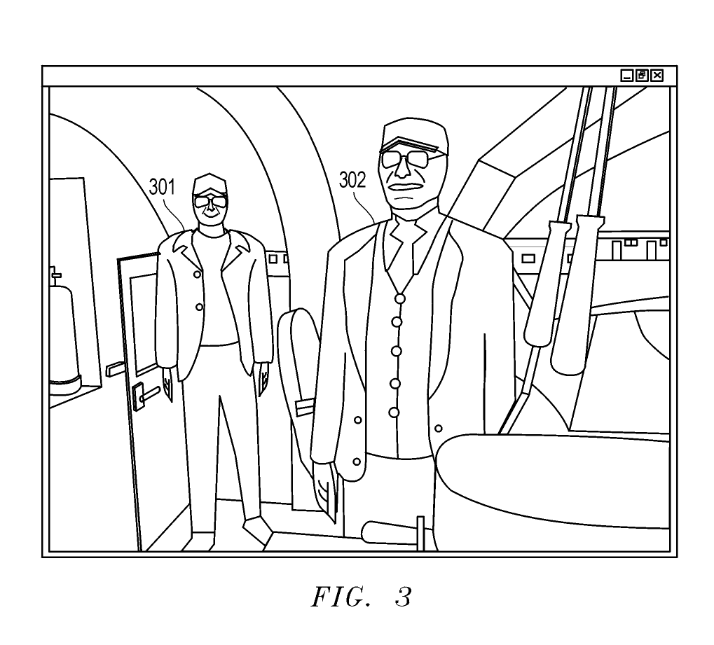

Although not the case in this example, as shown in FIG. 3, it is possible for two or more avatars 301 and 302 to occupy the same car. As shown in FIG. 3, two vehicle operator avatars 301 and 302 are shown in the locomotive. The two avatars can see and communicate with one another as further described herein.

For the user, as a conductor, to communicate with the other users as passengers, the user will depress the assigned key on the keyboard to bring up a text bar where the user can type in a sentence that will be sent to the other user through the simulator. In this manner, two way communications between the conductor and the passenger can occur. If headsets are available to both the conductor user and the passenger user, they can alternatively communicate through a Voice over Internet Protocol connection.

While all of these activities are commencing, the simulator is tracking how well the user is performing the job duties and reaching objectives. After the completion of the assigned job, the skills rating of each of the avatars is calculated and transmitted back to the simulator for storage and communication to the other users. The skill rating may effect and modify the experience that the user has with the on-going simulation. Since the tasks have been completed successfully, both the engineer avatar and the brakeman avatar will receive the maximum experience and currency credit stated in each task. Further, the skill ratings for each are adjusted through data from the grading and evaluation system.

As the user switches back to the engineer, a train is visible in the distance moving away. This train is being controlled by another user who placed a GPS real-time tracking device on a real-life locomotive. The real-time tracking device sends its location data to the simulator through a cellular connection to the Internet. This data is interpreted by the simulator and sent to all users of the same scenario. Another locomotive is seen arriving on track no. 2 and stopping. This locomotive is controlled by an engineer who is controlled entirely by the simulator.

The user may continue in the simulation and either new objectives will show up on the user interface or the user may continue with their own activities.

### EXAMPLE 2

During the previous example, if given permission from the simulator, at any time, the user may enter an editing mode. By depressing the assigned key on the keyboard for editing, the user can manipulate the objects in the simulation in real-time and, if on-line, collaborate with other users. Upon depressing the key for editing on the keyboard, the user is presented with an interface from which to choose an action. The available actions include create a new locomotive, car, track, object, or event, and modify a locomotive, car, track, object, or event.

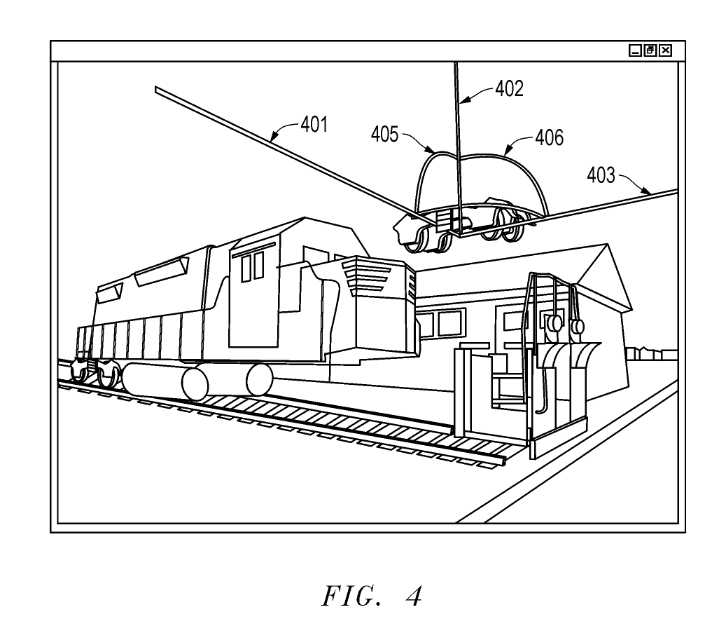

In this example, the user chooses “modify the locomotive” and uses the assigned mouse button to select a locomotive or locomotive part in the user view. As shown in FIG. 4, a 3D interface will appear, giving the user various manipulation tools. By clicking the assigned mouse button on one of the colored axis bars 401, 402 or 403 and dragging, the user will be able to move the part along the selected axis. By clicking the assigned mouse button on one of the quarter circle bars 405 or 406 and dragging, the user can rotate the part around that axis. By clicking the assigned mouse button on the “P” in the interface, the user can exchange the part with any successive part in the common parts library. By clicking the assigned mouse button on the “A”, the user can add a new part from the common parts library to the locomotive. By clicking the assigned mouse button on the “D”, the user can delete a part from the locomotive. By clicking the assigned mouse button on the “T”, the user can exchange the texture of the selected part with another texture in the simulation. By clicking the assigned mouse button on the “M”, the user can bring up an interface with more options for manipulating the locomotive or part. This option also allows the user to load and save locomotive assembly files, called “TAP” files, after the user has finished making modifications. As the user makes modifications, they are transferred to the simulator and then sent to all other users in the same simulation scenario. Each user can also manipulate and modify this same locomotive.

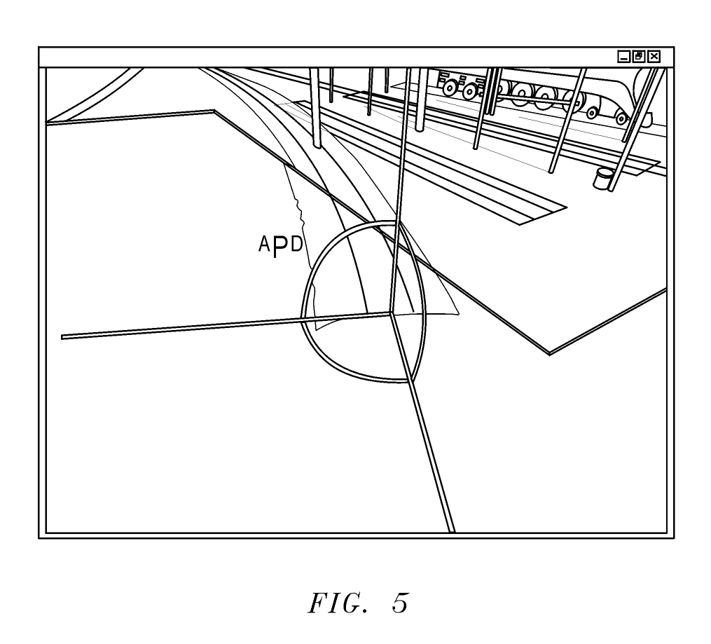

To modify tracks, the user selects the track segment with the assigned mouse button. As shown in FIG. 5, a track modify interface will appear along with two handles attached at both ends of the track segment. A handle may be selected by depressing the assigned mouse button over the handle. The handle can now be moved in much the same way as the locomotive parts were moved. Moving the handles changes the position, curvature and bank of the track segment. All changes are sent to the simulator which, in turn, sends the changes to all users in the same scenario. Multiple track segments can be manipulated at the same time by clicking and dragging a square around the tracks to select. Once all of the tracks are selected, any manipulation done to the interface will affect all selected track.

To modify connections, the user clicks on a switch with the assigned mouse button. A line will appear with one end at the switch and another end at a button in the control tower. There is a handle on each end of the connection line. By clicking on the handle with the assigned mouse button, the user can move this line end over another object. After which, an interface box will appear allowing the user to choose the connection channel as well as any other set-up specification for the connection. Once again, modification will be sent to the simulator and then to all users in the same simulation scenario.

To modify decision nodes, the user selects either the decision node entity or the connection line handle at which point a 3D modification interface will appear. This modification interface is the same as that for the locomotive interface. The only difference is when the user clicks to select the “M,” a menu interface will appear with an area to type in instructions to be used by the decision node to determine logic flow.

To add a new locomotive, the user selects the “New Locomotive” option in the interface with the assigned mouse button. By clicking near any track, a new locomotive appears, aligned to the track. This new locomotive can be manipulated as in the previous example.

To add a new Object, the user will select the “New Object” option in the interface with the assigned mouse button. By clicking anywhere on the terrain, a new object appears, aligned to the terrain. This new object can be manipulated as in the previous example.

To add a new track, the user will select the “New Track” option in the interface with the assigned mouse button. By clicking on the ground, a handle for the beginning of the track will appear. Clicking again will place the end handle of the line on the ground. The track can now be manipulated as in the previous example. Additionally, if the user desires to modify the terrain for the track, the user will select the “Modify Terrain” option from the interface. A 3D interface will appear, giving the user the same manipulation tools that were used for the locomotive modifications.

To add a new connection, the user will select the “New Connection” option in the interface with the assigned mouse button. By clicking over an object, locomotive, or track, a handle for one end of the connection will be placed. Clicking again on another object, track, or locomotive will place the other end handle. After which an interface will appear allowing the user to choose the connection channel as well as any other set-up specification for the connection. All additions will be sent to the simulator and then sent to all users in the same simulation scenario.

To add a new decision node, the user will select “New Decision” from the interface. Clicking anywhere in the virtual world with the selected mouse button will result in a new decision node being placed which can now be modified with the method described above.

While the present invention has been disclosed according to the preferred embodiment, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of possible of simulations, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

What is claimed is:

1. A mass transportation simulator comprising:
a simulator in which one or more users may interact through an avatar with one or more vehicles, wherein said avatar is able to move in, on or around said vehicle during a simulation.

2. The simulator of claim 1 wherein said avatar of one user interacts with one or more avatars of other users.

3. The simulator of claim 1 wherein said one or more users' concurrently access said simulator through a network.

4. The simulator of claim 1 further including a common parts library which may be accessed by said user for the creation of vehicles, track or roads and wherein said user may interactively create said vehicles, track and roads in said simulator.

5. The simulator of claim 4 wherein tools for performing said creation of said vehicles, track or roads are concurrently accessible to multiple users so that multiple users may work on said creation simultaneously.

6. The simulator of claim 1 wherein said user interacts with said avatar through a cell phone, Sony PlayStation Portable or similar device, personal digital assistant, or other device communicatively coupled to the Internet.

7. The simulator of claim 1 wherein said simulator can be controlled by an external device such as a GPS transmitter.

8. The simulator of claim 1 wherein the appearance of said avatar may be customized by said user.

9. The simulator of claim 1 wherein view of different areas of said simulator are displayed in one or more windows.

10. The simulator of claim 1 wherein said simulator collects data related to said user's performance and makes adjustments in the operation of said simulator depending on said data.

11. A mass transportation simulator comprising:
a simulator in which tasks are offered for bid to one or more users;
the winning bidder is provided information about the task to be completed;
the simulator monitors and evaluates said winning bidder's performance of said task;
upon satisfactory completion of said task, said winning bidder is issued credits and/or data that represent said winning bidder's experience and skill based on said evaluation.

12. The simulator of claim 11 wherein said simulator adjusts the difficulty of future tasks for said winning bidder based on said evaluation.

13. The simulator of claim 11 wherein said credits are issued to said wining bidder on a pro-rated basis based on said winning bidder's skills.

14. The simulator of claim 11 wherein said simulator includes a method for banking, trading and exchanging said credits.

15. The simulator of claim 11 wherein said simulator includes advertising on store fronts thereby allowing real world vendors to market and sell products to users.

16. The simulator of claim 11 wherein the views in said simulator made be modified to appear as different eras.

17. The simulator of claim 11 wherein said simulator includes real world sound effects.

18. The simulator of claim 11 wherein said simulator can control a vehicle, an object, or an avatar within said simulator to provide instruction to said user.

19. The simulator of claim 11 wherein said one or more users' concurrently access said simulator through a network.

20. A mass transportation simulator comprising:
means for allowing one or more users in a simulator to interact through one or more avatars with one or more vehicles, and a means for said avatar to move in, on or around said vehicle during a simulation.
